(19) United States
(12) Patent Application Publication
(10) Pub. No.: US 2015/0194771 A1
(43) Pub. Date: Jul. 9, 2015

(54) ELECTRICAL CONNECTOR

(71) Applicant: FOXCONN INTERCONNECT TECHNOLOGY LIMITED, Grand Cayman (KY)

(72) Inventor: FENG PAN, Kunshan (CN)

(21) Appl. No.: 14/594,037

(22) Filed: Jan. 9, 2015

(30) Foreign Application Priority Data
Jan. 9, 2014 (CN) 201410009789.7

(51) Int. Cl. H01R 13/6587

(52) U.S. Cl. CPC H01R 13/6587

(57) ABSTRACT

An electrical connector including: an insulative base having a number of receiving grooves and a front mating face, the mating face defining a number of L-shaped receiving holes; and a number of stacked terminal modules, the terminal module having an insulative body, a number of conductive terminals received in the insulative body, a spacer received in the receiving groove, and a shielding plate mounted on one side of the insulative body, the conductive terminals comprising plural pairs of signal terminals for transmitting differential signals and plural grounding terminals alternately arranged with the signal terminal pairs. The mating face defines a plurality of slots, the L-shaped receiving hole having a short side and a long side perpendicular to the short side, the slot connecting with the short side, the grounding terminal received in the slot, the shielding plate received on side of the long sides of the L-shaped receiving holes.

### BACKGROUND OF THE INVENTION

1. Field of the Invention

The present invention relates to an electrical connector and especially relates to terminals of the electrical connector.

2. Description of Related Art

U.S. Pat. No. 6,899,566 discloses an electrical connector including an insulative base and a number of terminal modules arranged in a transverse direction. The terminal module includes an insulative housing, a number of conductive terminals received in the insulative housing, a spacer for insulating adjacent two rows of conductive terminals, and a shielding plate mounted on one side of the insulative housing.

U.S. Pat. No. 7,131,870 discloses an electrical connector including an insulative base and a number of terminal modules received in the insulative base. The terminal module includes an insulative housing and a number of conductive terminals received in the insulative housing and arranged in a vertical direction. The conductive terminals include plural pairs of signal terminals and plural grounding terminals alternately arranged with respect to the signal pairs. The insulative base defines a number of receiving holes. Each of the conductive terminals is received in a corresponding receiving hole. Two adjacent pairs of signal terminals are shielded by a grounding terminal in the same terminal module.

An improved electrical connector is desired.

### SUMMARY OF THE INVENTION

Accordingly, an object of the present invention is to provide an electrical connector having an insulative base, the insulative base having a different structure.

In order to achieve the object set forth, the invention provides an electrical connector comprising:

an insulative base having a plurality of receiving grooves and a front mating face, the mating face defining a plurality of L-shaped receiving holes; and

a plurality of terminal modules arranged in a transverse direction, the terminal module comprising an insulative body, a plurality of conductive terminals received in the insulative body, a spacer received in the receiving groove for insulating the conductive terminals of two adjacent terminal modules, and a shielding plate mounted on one side of the insulative body, the conductive terminals comprising plural pairs of signal terminals for transmitting differential signals and plural grounding terminals alternately arranged with the signal terminals, the signal terminal comprising a contact portion received in the spacer;

wherein the mating face defines a plurality of slots, the L-shaped receiving hole having a short side and a long side perpendicular to the short side, the slot connecting with the short side, the grounding terminal received in the slot, the shielding plate received on side of the long sides of the L-shaped receiving holes.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of an electrical connector according to the present invention cooperating with a mating connector;

FIG. 2 is a perspective view of an electrical connector not cooperating with a mating connector as shown in FIG. 1;

FIG. 3 is an another perspective view of an electrical connector not cooperating with a mating connector as shown in FIG. 2;

FIG. 4 is an explosive view of the electrical connector according to the present invention;

FIG. 5 is an another explosive view of the electrical connector as shown in FIG. 4;

FIG. 6 is a top view of the insulative base according to the present invention;

FIG. 7 is a cross-sectional view of the electrical connector taken along line A-A of FIG. 2; and

FIG. 8 is a perspective view of conductive terminals connecting with the mating contacts of the mating connector.

### DETAILED DESCRIPTION OF THE PREFERRED EMBODIMENT

Reference will now be made in detail to the preferred embodiment of the present invention.

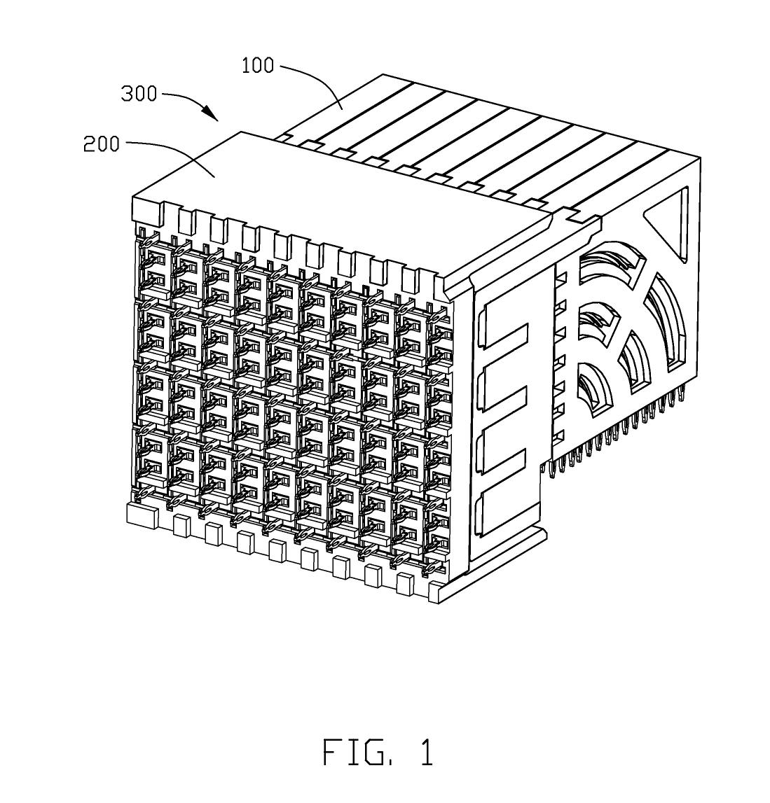

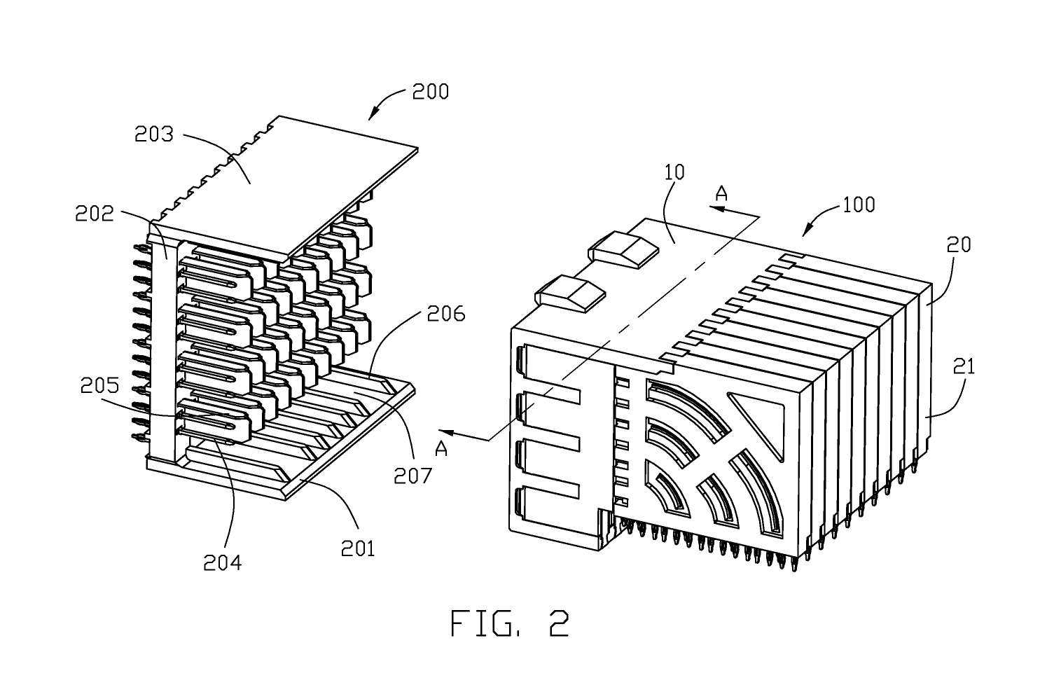

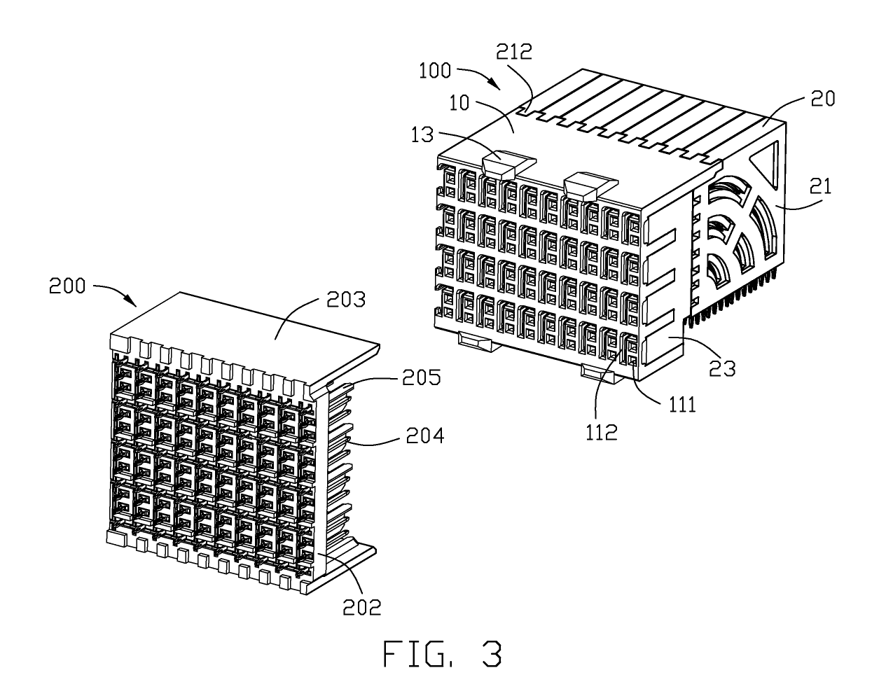

Referring to FIG. 1 to FIG. 3, a connector assembly 300 includes an electrical connector 100 and a mating connector 200 cooperating with the electrical connector 100.

The mating connector 200 includes a U-shaped receiving base 201, a number of mating contacts 204, and a number of L-shaped grounding contacts 205. The receiving base 201 includes a bottom wall 202 and two side walls 203. The mating contacts 204 and L-shaped grounding contacts 205 are arranged in array. The L-shaped grounding contact 205 is in two adjacent sides of the pair of the mating contacts 204. The two side walls 203 define a number of ribs 206 and a guide groove 207 forming between the two adjacent ribs 206.

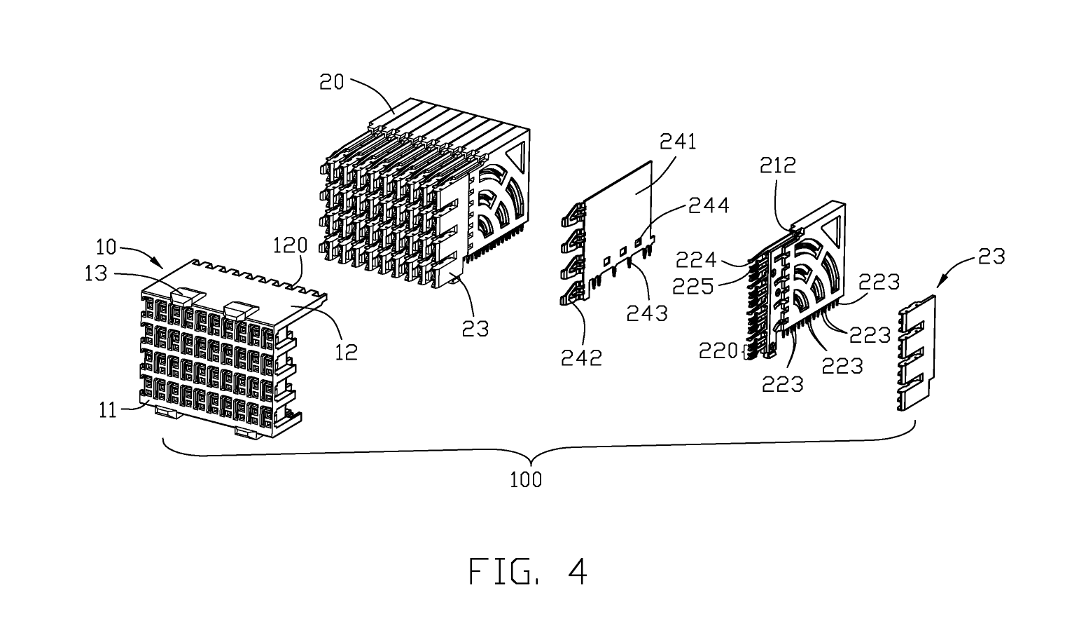

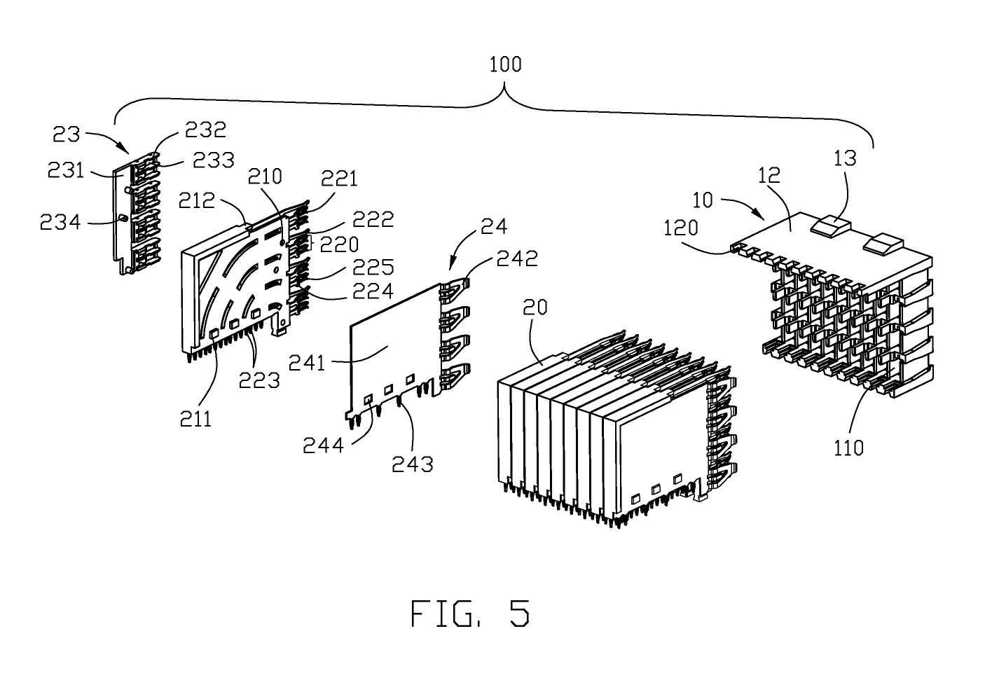

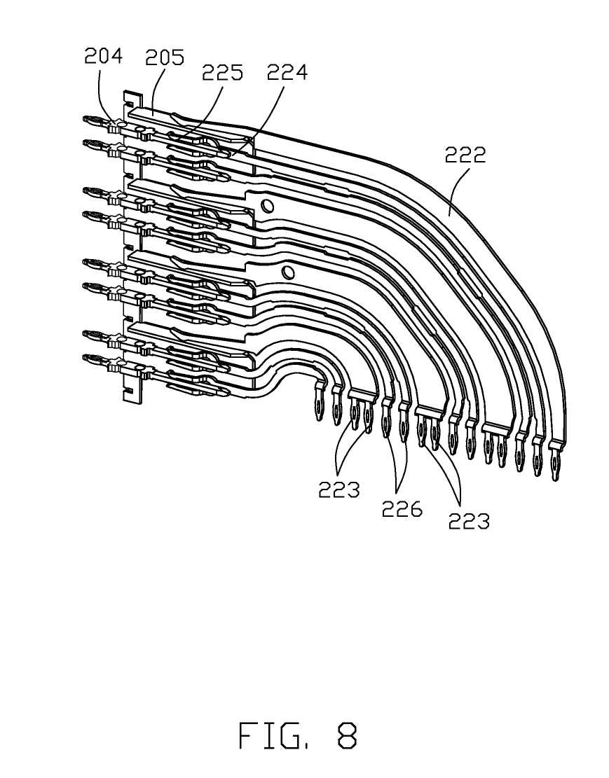

Referring to FIG. 4, FIG. 5 and FIG. 8, the electrical connector 100 includes an insulative base 10 and a number of terminal modules 20 arranged in a transverse direction. The terminal module 20 includes an insulative body 21, a number of conductive terminals 22 arranged in array, a spacer 23 mounted on the insulative body 21 and a shielding plate 24 mounted on one side of the insulative body 21. The conductive terminals 22 include a number of signal terminals 221 for transmitting differential signal. Each of two adjacent signal terminals 221 forms a pair of signal terminals 220. The conductive terminal 22 also includes a number of grounding terminals 222 alternately arranged with the pair of signal terminals 220. This design makes the adjacent two pairs of signal terminals 220 not product the signal interference.

The grounding terminal 222 includes a main body received in the insulative body 21 and a first grounding foot 223 extending out the insulative body 21. The signal terminal 221 includes a contact portion 224 extending beyond the insulative body 21. Each of the contact portions 224 has two contact ends 225. Each of the spacer 23 includes a body portion 231 and a number of limbs 232 extending from the body portion 231. Each of the limbs 232 has two terminal receiving passageways 233 for receiving the corresponding contact portion 224 of the signal terminal 221. The body portion 231 of the spacer 23 has a number of second posts 234. The insulative body 21 has number of second mounting holes 210. The second posts 234 are fixed in the second mounting holes 210. So the spacer 23 and the terminal module 20 insert into the insulative base 10 together to avoid damaging the contact portion 224 of the signal terminal 221.

The shielding plate 24 is in one side of the terminal module 20. The shielding plate 24 has a main part 241, a number of spring arms 242 forward extending from the main part 241, and a number of grounding legs 243 downward extending from the main part 241. The main part 241 has a number of first mounting holes 244, the insulative body 21 having a number of first posts 211, the first posts 211 being fixed in the first mounting holes 244. When the shielding plate 24 is mounted on the insulative body 21, the spring arm 242 of the shielding plate 24 is in one side of the contact portion 224 of the pair of signal terminals 220. The signal terminal 221 also includes a mounting foot 226. Each shielding plate 24 has four middle grounding legs 243 and two side grounding legs 243. Each of the four middle grounding legs 243 is staggerly opposite to the corresponding mounting feet 226 of the pair of the signal terminals 220.

The insulative body 21 has a tuber 212 on the top. The insulative base 10 includes a mating face 11 and a side 12 vertically extending from the mating face 11. The side 12 has a number of recesses 120 at the end of the side 12. When the terminal module 20 is mounted into the insulative base 10, the tuber 212 is received in the corresponding recess 120. So the terminal module 20 and insulative base 10 are assembled more firmly.

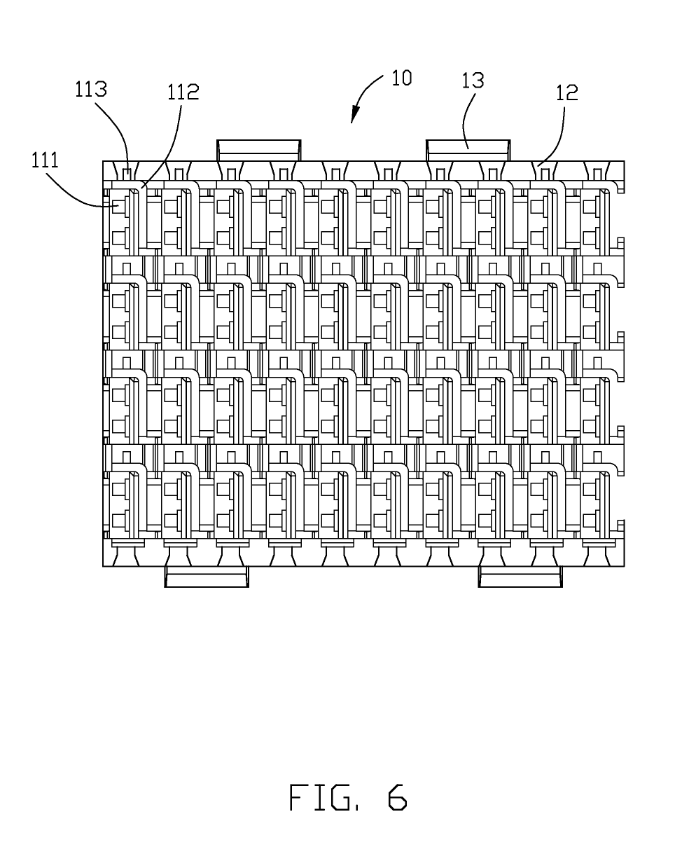

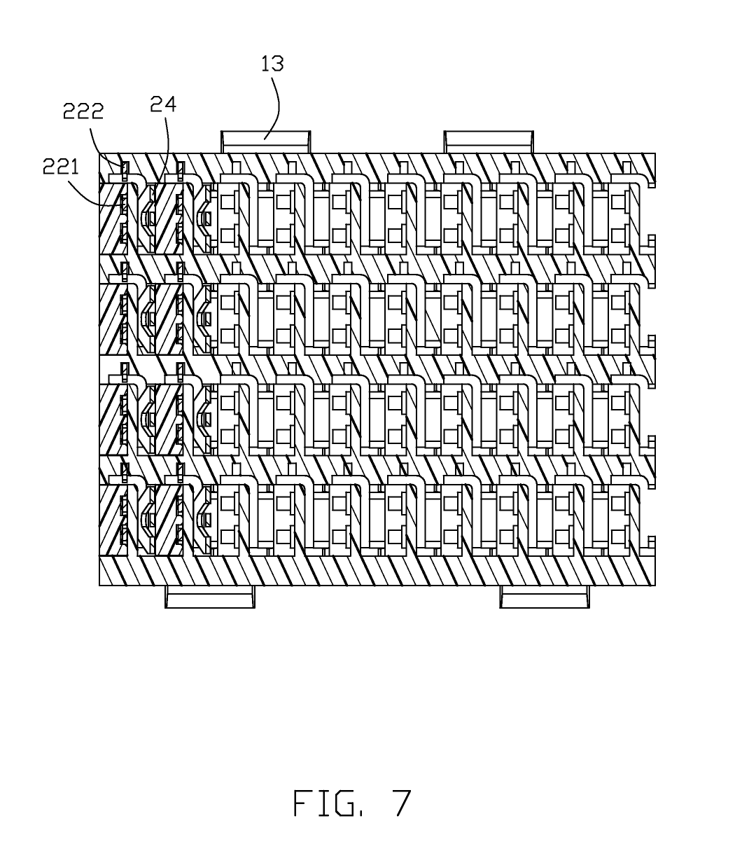

Referring to FIG. 6 to FIG. 7, the insulative base 10 defines a number of receiving grooves 110. Each of the receiving grooves 110 is opposite to two signal receiving holes 111, an L-shaped receiving hole 112 and a slot 113. The L-shaped receiving hole 112 has a short side and a long side perpendicular to the short side, the slot 113 connecting with the short side. The grounding terminal 222 received in the slot 113, the shielding plate 24 received on side of the long side. The L-shaped receiving hole 112 partly surrounds the signal receiving hole 111. The slot 113 extends behind the front mating face 11 of the insulative base 10. The grounding terminal 222 also includes a contact end 227 extending from the main body of the grounding terminal 222 and extending to the slot 113. The front part of the contact end 227 is received in the slot 113. When the electrical connector 100 cooperates with the mating connector 200, the contact end 227 of the grounding terminal 222 contacts with one side of the L-shaped grounding contact 205, the spring arms 242 of the shielding plate 24 contacts with the other side of the L-shaped grounding contact 205. The slot 113 and two signal receiving holes 111 are disposed in a line. The short side of the L-shaped receiving hole 112 is positioned between the slot 113 and the two signal receiving holes 111.

Referring to FIG. 8, each side of the insulative base 10 has two tabs 13 received in the guide groove 207 of the mating connector 200. When the electrical connector 100 cooperates with the mating connector 200, the mating contacts 204 insert between two contact ends 225 of the signal terminals 221 in the signal receiving hole 111 for realizing electric connection. At the same time, the L-shaped grounding contact 205 electrically connects with the spring arm 242 of the shielding plate 24 in the L-shaped receiving hole 112 and the grounding terminal 222 also electrically connects with the L-shaped grounding contact 205. So the adjacent two pairs of signal terminal 220 will not produce interference.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the members in which the appended claims are expressed.

What is claimed is:

1. An electrical connector comprising:
an insulative base having a plurality of receiving grooves and a front mating face, the mating face defining a plurality of L-shaped receiving holes; and
a plurality of terminal modules arranged in a transverse direction, the terminal module comprising an insulative body, a plurality of conductive terminals received in the insulative body, a spacer received in the receiving groove for insulating the conductive terminals of two adjacent terminal modules, and a shielding plate mounted on one side of the insulative body, the conductive terminals comprising plural pairs of signal terminals for transmitting differential signals and plural grounding terminals alternately arranged with the signal terminals, the signal terminal comprising a contact portion received in the spacer;
wherein the mating face defines a plurality of slots, the L-shaped receiving hole having a short side and a long side perpendicular to the short side, the slot connecting with the short side, the grounding terminal received in the slot, the shielding plate received on side of the long sides of the L-shaped receiving holes.

2. The electrical connector as claimed in claim 1, wherein the mating face defines two signal receiving holes, the L-shaped receiving hole partly surrounding the signal receiving holes.

3. The electrical connector as claimed in claim 2, wherein the grounding terminal has a main body and a contact end extending from the main body into a corresponding slot.

4. The electrical connector as claimed in claim 2, wherein the slot and the two associated signal receiving holes are disposed in a line, and the short side of the L-shaped receiving hole is positioned between the slot and the two associated signal receiving holes.

5. The electrical connector as claimed in claim 2, wherein the slot extends behind the front mating face of the insulative base.

6. The electrical connector as claimed in claim 1, wherein the insulative body defines a plurality of first posts, and the shielding plate has a plurality of first mounting holes receiving the first posts.

7. The electrical connector as claimed in claim 1, wherein the shielding plate defines a plurality of grounding legs, and the signal terminal has a mounting foot, the grounding legs being staggerly opposite to the mounting feet of the plural pairs of signal terminals.

8. The electrical connector as claimed in claim 1, wherein the spacer comprises a body portion and a plurality of limbs extending from the body portion, the body portion having a second post, the insulative body having a second mounting hole receiving the second post.

9. The electrical connector as claimed in claim 8, wherein each of the limbs has two terminal receiving passageways, the contact portions of the pair of signal terminals being received in the terminal receiving passageways.

10. An electrical connector assembly comprising:
a first electrical connector including:
an insulative base defining a plurality of receiving hole sets arranged in matrix and extending through the base in a front-to-back direction, each of said receiving hole sets including a pair of first through holes and an L-shaped second through hole beside said pair of first through holes;
a plurality of terminal modules located behind the base in said front-to-back direction and stacked with one another along a transverse direction perpendicular to said front-to-back direction, each of said terminal modules including an insulator, a plurality of differential pairs embedded within the insulator via an insert-molding process in essentially a vertical plane perpendicular to said transverse direction, a metallic shielding plate attached on one side of the insulator; wherein
each differential pair has corresponding front contacting sections located behind and aligned with the corresponding first through holes in the front-to-back direction, respectively, for electrically and mechanically connecting with another differential pair of a second connector; wherein
each shielding plate includes a plurality of spring arms each extending forwardly to reach a position proximate the corresponding second through hole for electrically and mechanically connecting to an L-shaped grounding contact of the second connector.

11. The electrical connector assembly as claimed in claim 10, wherein each of said terminal modules further includes a plurality of grounding terminals alternately arranged with the corresponding differential pairs in said vertical plane, and each grounding terminal includes a front contacting section extending into the insulative base to reach a position proximate the corresponding second through hole.

12. The electrical connector assembly as claimed in claim 11, wherein each of the receiving hole sets further includes a slot in communication with the corresponding second through hole to receive the front contacting section of the corresponding grounding terminal for contacting the corresponding grounding contact of the second connector.

13. The electrical connector assembly as claimed in claim 11, wherein the front contacting section of the grounding terminal is located around a short side of the corresponding L-shaped second through hole while the spring arm is located around a long side of the corresponding L-shaped second through hole.

14. The electrical connector assembly as claimed in claim 10, wherein each of the terminal modules further includes an insulative spacer defining a plurality of channels to separate the front contacting sections of the differential pairs from each other in a vertical direction perpendicular to both said front-to-back direction and said transverse direction.

15. The electrical connector assembly as claimed in claim 14, wherein the insulative spacer is attached to a front region of the corresponding insulator.

16. The electrical connector assembly as claimed in claim 10, wherein each of the front contacting sections of the differential pair is curved in the transverse direction and forms a fork configuration viewed in the transverse direction for sandwiching therebetween a pin of the corresponding differential pair of the second connector in a vertical direction perpendicular to both said front-to-back direction and said transverse direction.

17. The electrical connector assembly as claimed in claim 16, wherein the fork configuration includes a base from which a pair of spaced deflectable arms forwardly extend and being curved in a top view so as to allow the corresponding pin of the second connector to located beside said base while being sandwiched by said pair of deflectable arms in the vertical directon.

18. An electrical connector assembly comprising:
an insulative base defining a plurality of receiving hole sets arranged in matrix formed by columns and rows, and extending through the base in a front-to-back direction, each of said receiving hole sets including a pair of first through holes and an L-shaped second through hole beside said pair of first through holes;
corresponding to each of said columns, a terminal module being located behind the base in the front-to-back direction, and including an insulator to retain therein a plurality of differential pairs and a plurality of grounding terminals which are alternately arranged with each other in essentially a vertical plane perpendicular to a row direction which is perpendicular to said front-to-back direction, and a shielding plate attached on one side of the insulator in said row direction with a plurality of spring arms unitarily associated thereon; and
a second connector including:
an insulative housing retaining a plurality of differential pairs and a plurality of L-shaped grounding contacts arranged by pairs; wherein during mating between the first connector and the second connector,
in each pair, the differential pairs of the second connector are received in the pair of first through holes to electrically and mechanically connect to the corresponding differential pair of the first connector, and the L-shaped grounding contact is received within the L-shaped second through hole to electrically and mechanically connect to both the corresponding grounding terminal and the corresponding spring arm of the shielding plate.

19. The electrical connector assembly as claimed in claim 18, wherein the base further includes a plurality of slots in which front ends of the corresponding grounding terminals are received, respectively.

20. The electrical connector assembly as claimed in claim 18, wherein in each pair of the second connector, the corresponding grounding terminal of the first connector contacts a short side of the grounding contact while the corresponding spring arm of the shielding plate contacts a long side the grounding contact.
